(19) United States
(12) Patent Application Publication
(10) Pub. No.: US 2015/0019349 A1
(43) Pub. Date: Jan. 15, 2015

(54) PACKS OF INVENTORY

(71) Applicant: Google Inc., Mountain View, CA (US)

(72) Inventors: Peter L. Milley, Kitchener (CA); Drew Bradstock, Kitchener (CA); Matthew Young-Lai, Kitchener (CA)

(21) Appl. No.: 13/938,810

(22) Filed: Jul. 10, 2013

(51) Int. Cl. G06Q 30/02

(52) U.S. Cl. CPC G06Q 30/0275
USPC 705/14.71

(57) ABSTRACT

A method includes receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier. The method includes receiving a request for a content item associated with the inventory of content item slots; and in response to the request, performing a content auction, including providing the first identifier, the second identifier, or both, based on the branding tier.

### TECHNICAL FIELD

This disclosure relates generally to providing tiered packs of inventory for distribution at a content auction.

### BACKGROUND

The Internet provides access to a wide variety of resources. For example, video, audio, and Web pages are accessible over the Internet. These resources present opportunities for other content (e.g., advertising or non-advertising content, such as audio, video, or the like) to be provided with the resources. For example, a Web page can include slots in which content can be presented. Similarly, such slots can be part of television programming.

Slots can be allocated to content providers (e.g., advertisers). In some systems, a network can be used to allocate content to the slots based, e.g., on various factors relating to the content and the context in which it is to be presented. For example, the content can be allocated based, in part, on keywords input to a system, such as a search engine. An online content auction can be performed for the right to present advertising in a slot. In the auction, content sponsors provide bids specifying amounts that the content sponsors are willing to pay for presentation of their content. Typically, the winning bidder is given the right to present content.

### SUMMARY

In a general aspect, a method performed by one or more processing devices includes receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier. The method includes receiving a request for a content item associated with the inventory of content item slots; and in response to the request, performing a content auction, including providing the first identifier, the second identifier, or both, based on the branding tier.

In a general aspect, one or more machine-readable storage media store instructions that are executable by one or more processing devices to perform operations including receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier. The operations include receiving a request for a content item associated with the inventory of content item slots; and in response to the request, performing a content auction, including providing the first identifier, the second identifier, or both, based on the branding tier.

In a general aspect, a system includes a content management system for performing operations including receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier. The operations include receiving a request for a content item associated with the inventory of content item slots; and in response to the request, performing a content auction, including providing the first identifier, the second identifier, or both, based on the branding tier.

Embodiments may include one or more of the following features.

The first identifier includes one or more of an identifier of the one or more publishers, an identifier descriptive of the one or more publishers, an identifier of a consortium to which the one or more publishers belong, and an identifier descriptive of a domain associated with the inventory.

The second identifier includes an identifier descriptive of a topic associated with the inventory of content item slots, an identifier descriptive of a technical feature associated with the inventory of content item slots, or both.

Performing the auction comprises providing a domain associated with the requested content item, a resource associated with the requested content item, or both, based on the branding tier.

Performing the auction comprises providing an anonymous identifier associated with the one or more publishers based on the branding tier.

The method includes receiving, from the one or more publishers, a specification of the branding tier.

The first identifier is associated with one or more of at least three branding tiers.

The method includes receiving, from the one or more publishers, a rule associated with the inventory of content item slots. In some cases, the rule is associated with the branding tier. In some cases, the rule is indicative of one or more content providers that are allowed to bid on a content item slot associated with the inventory of content item slots, one or more content providers that are not allowed to bid on a content item slot associated with the inventory of content item slots, or both. In some cases, the rule is indicative of a minimum price associated with the inventory of content item slots.

In a general aspect, a method performed by one or more processing devices includes receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier. The method includes receiving a request for a content item associated with the inventory of content item slots and associated with a particular resource of the one or more publishers; and in response to the request, performing a content auction in which the information provided in the content auction is based at least in part on the branding tier and includes the first identifier and the second identifier but not the particular resource.

In a general aspect, one or more machine-readable storage media store instructions that are executable by one or more processing devices to perform operations including receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier. The operations include receiving a request for a content item associated with the inventory of content item slots and associated with a particular resource of the one or more publishers; and in response to the request, performing a content auction in which the information provided in the content auction is based at least in part on the branding tier and includes the first identifier and the second identifier but not the particular resource.

In a general aspect, a system includes a content management system for performing operations including receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier. The operations include receiving a request for a content item associated with the inventory of content item slots and associated with a particular resource of the one or more publishers; and in response to the request, performing a content auction in which the information provided in the content auction is based at least in part on the branding tier and includes the first identifier and the second identifier but not the particular resource.

Embodiments may include one or more of the following features.

The first identifier includes one or more of an identifier descriptive of the one or more publishers, an identifier of a consortium to which the one or more publishers belong, and an identifier descriptive of a domain associated with the inventory.

The first identifier, the second identifier, or both, are specified by the one or more publishers.

The second identifier includes an identifier descriptive of a topic associated with the inventory of content item slots, an identifier descriptive of a technical feature associated with the inventory of content item slots, or both.

The method includes receiving, from the one or more publishers, a rule associated with the inventory of content item slots. In some cases, the rule is indicative of one or more content providers that are allowed to bid on a content item slot associated with the inventory of content item slots, one or more content providers that are not allowed to bid on a content item slot associated with the inventory of content item slots, or both. In some cases, the rule is indicative of a minimum price associated with the inventory of content item slots.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features and advantages will be apparent from the description and drawings, and from the claims.

### DESCRIPTION OF THE DRAWINGS

FIG. 1 is a block diagram of an example network environment on which the example processes described herein can be implemented.

FIG. 2 is an example of a process for providing one or more packs of inventory.

FIG. 3 is an example of a process for providing a pack of inventory.

FIG. 4 is a block diagram of packs of inventory.

FIG. 5 is an example of a computer system on which the processes described herein may be implemented.

Like reference symbols in the various drawings indicate like elements.

### DETAILED DESCRIPTION

Content, such as advertising, may be provided to network users based, e.g., on demographics, keywords, language, and interests. For example, advertising (an “ad”) may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on the results page. The user may select the ad by clicking-on the ad. In response, a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

A content auction may be run to determine which content is to be output in response to an input. In the auction, content providers may bid on specific slots or information associated with those slots, such as keywords. The content provider may bid in the content auction, e.g., on a cost-per-click (CPC) basis or a cost per thousand impressions (CPM) basis. The content provider's bid is an amount (e.g., a maximum amount) that the provider will pay in response to users clicking on or displaying their content. So, for example, if a content provider bids five cents per click, then the content provider may pay five cents each time their content is clicked-on by a user, depending upon the type of the auction. In another example, a bidder pays each time one thousand impressions of its content are displayed. In other examples, payment may be on the basis of other actions (e.g., an amount of time spent on a landing page, a purchase, and so forth).

Bidding in a content auction typically takes place against other content providers. The content auction is run (e.g., by the content management system) to determine which content to serve along with search results or any other requested content. Typically, the winner of the content auction obtains the most preferred slots on a results page. The winner may be decided, e.g., based on bidding price or other factors. In this context, a page includes any display area, such as a Web page, a continuously scrollable screen, and so forth. In some examples, winners of the auction will be accorded the most preferred slot(s) on the page, while others will be accorded slots that are less preferred.

In some implementations, a group of one or more slots can be provided for sale in a content auction as a pack of inventory. A pack of inventory can include slots provided by a single publisher or by multiple publishers, such as by a consortium of publishers. For instance, a pack of inventory can include slots on one or more pages published by a single publisher or slots on pages published by multiple publishers.

A pack of inventory can be bid on as a single placement by a bidder in a content auction. That is, rather than bidding on each slot individually, a bidder can bid on a pack of inventory that includes one or more slots. A winning bid on a pack of inventory allows the winning bidder to display content in one of the slots included in the pack. That is, for instance, when a user views a site containing any of the slots included in a pack of inventory, bidders are given the opportunity to bid on that pack of inventory. Content from the winning bidder is displayed in the slot being viewed by the user.

The information exposed in a content auction about the source of a pack of inventory and the features of the inventory in the pack (e.g., the topics of the pages, technical characteristics of the inventory, or other features) can be controlled by the publisher of the pack of inventory. In particular, publishers can independently control information about the source of the inventory and information about the features of the inventory. This control allows publishers to dynamically segment inventory based on properties of individual impressions, to sell a group of inventory as a bundle, and to brand the inventory as desired. In addition, this control can be enabled on a per-bidder basis, enabling the publisher to exercise fine-grained control over the information that is exposed to individual bidders.

In some implementations, each pack of inventory can be associated with a source identifier that identifies or describes the source of the inventory (e.g., the publisher, a consortium to which the publisher belongs, or a domain of the pages on which the slots in the pack appear). Each pack of inventory can also be associated with a pack name. The pack name can be an identifier that is descriptive of one or more features of the inventory in the pack, such as the topic of the pages on which the slots in the pack appear or a technical feature of the slots in the pack. The publisher of a pack of inventory can specify the source identifier, the pack name, or both, thus controlling the descriptive identifiers that are associated with the pack.

The publisher can control the amount of information about the pack of inventory that is exposed to bidders by designating the pack of inventory as one or more of multiple branding tiers, such as one of three or more branding tiers. The branding tier of a pack of inventory is a characteristic of the pack of inventory that controls how much information about the pack of inventory is exposed to bidders. In some implementations, three branding tiers are available, and a different amount of information about a pack of content inventory is exposed for each branding tier. Furthermore, the information that is exposed for each branding tier can be specified by the publisher.

In a lowest tier, referred to as anonymous packs, no information about the source of the inventory is exposed to bidders. The source identifier for an anonymous pack is an anonymous identifier (e.g., a string of random numbers) that provides no information about the publisher of the pack or the domain(s) of the slots included in the pack. The pack name, which can be specified by the publisher, can be exposed to bidders. Thus, bidders can bid on an anonymous pack based only on the pack name.

In a middle tier, referred to as semi-transparent packs, the source identifier is a descriptive identifier of the source of the inventory that does not necessarily explicitly identify the source. The source identifier for a semi-transparent pack of inventory can be specified by the publisher of the pack, and as such, the publisher can control how much information about the source is revealed by the source identifier. For instance, the source identifier for a semi-transparent pack of inventory can be a description of the publisher, a consortium to which the publisher belongs, a domain of the inventory in the pack, or another descriptive identifier. In an example, the inventory in a semi-transparent pack is provided by the publisher “Books For You, Inc.” and includes slots on a page “www.books4you.com/cookbooks.” The publisher can specify a source identifier for that semi-transparent pack, such as a description of the publisher (e.g. “Book_Retailer”), a consortium to which the publisher belongs (e.g., “Online_Commerce_Association,” a domain of the inventory (e.g., “books4you.com”), or another descriptive identifier of the publisher. In some implementations, other information about a semi-transparent pack can be exposed to bidders, such as the domain of the inventory. The pack name, which can be specified by the publisher, can also be exposed to bidders. Thus, bidders can bid on a semi-transparent pack based on the pack name and based on some information specified by the publisher about the source of the inventory.

In a highest tier, referred to as branded packs, the publisher can specify detailed information about the source of the inventory that can be exposed to bidders. In some examples, the publisher can specify the publisher name as the source identifier and can allow other information that explicitly identifies the source of the inventory to be exposed to bidders. For instance, the publisher can allow the domain(s) of pages on which slots included in the pack appear, a resource identifier (e.g., the URL(s)) of the pages, the names of publishers, or other specific information to be exposed. In the example above, the publisher may specify t the name of the publisher (e.g., “Books_For_You_Inc.”) as the source identifier for a pack of branded inventory and may specifyother information, such as the URL of the page on which the inventory appears (e.g., “www.books4you.com/shoes”), to be exposed to bidders. The pack name, which can be specified by the publisher, can also be exposed to bidders. Thus, bidders can bid on a branded pack based on the pack name and based on a detailed set of information specified by the publisher about the source of the inventory.

In some implementations, rules can be applied to packs of inventory. For instance, a publisher can specify bidders that are allowed to bid on (or are prohibited from bidding on) packs at each branding tier. For instance, a publisher may offer the same set of inventory as an anonymous pack, a semi-transparent pack, and a branded pack, and allow different bidders to have access to each pack. A publisher can also specify a minimum bid price, such as a minimum CPC or a minimum CPM, for each pack. For instance, a publisher may offer the same inventory as an anonymous pack with a very low minimum bid price, as a semi-transparent pack with a moderate minimum bid price, and as a branded pack with a high bid price. That is, a publisher can control how much information about a pack is exposed to bidders and can charge a premium for access to more detailed information.

The example process described herein can be implemented in any appropriate network environment, with any appropriate devices and computing equipment. An example of such an environment is described below.

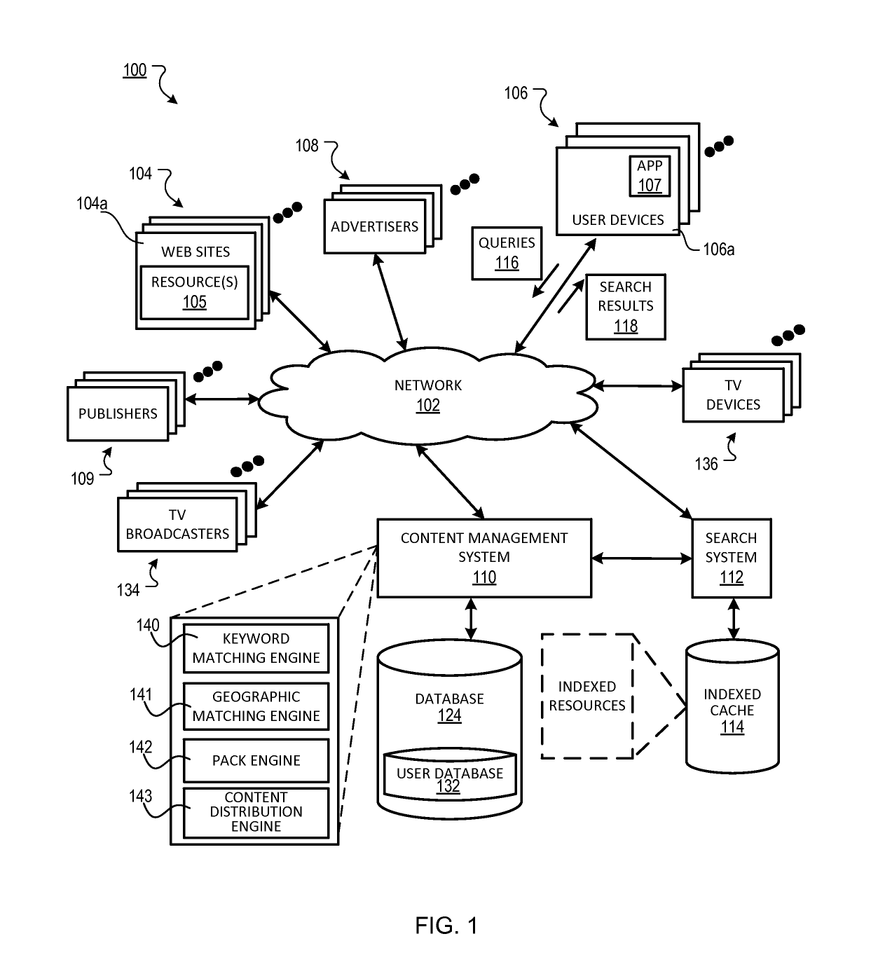

FIG. 1 is a block diagram of an example environment 100 for providing tiered packs of inventory for distribution at a content auction as described herein. The example environment 100 includes a network 102.

Network 102 can represent a communications network that can allow devices, such as a user device 106a, to communicate with entities on the network through a communication interface (not shown), which can include digital signal processing circuitry. Network 102 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 102 connects various entities, such as Web sites 104, user devices 106, content providers (e.g., advertisers 108), online publishers 109, and a content management system 110. In this regard, example environment 100 can include many thousands of Web sites 104, user devices 106, and content providers (e.g., advertisers 108). Entities connected to network 102 include and/or connect through one or more servers. Each such server can be one or more of various forms of servers, such as a Web server, an application server, a proxy server, a network server, or a server farm. Each server can include one or more processing devices, memory, and a storage system.

In FIG. 1, Web sites 104 can include one or more resources 105 associated with a domain name and hosted by one or more servers. An example Web site 104a is a collection of Web pages formatted in hypertext markup language (HTML) that can contain text, images, multimedia content, and programming elements, such as scripts. Each Web site 104 can be maintained by a publisher 109, which is an entity that controls, manages and/or owns the Web site 104.

A resource 105 can be any appropriate data that can be provided over network 102. A resource 105 can be identified by a resource address that is associated with the resource 105. Resources 105 can include HTML pages, word processing documents, portable document format (PDF) documents, images, video, and news feed sources, to name a few. Resources 105 can include content, such as words, phrases, images and sounds, that can include embedded information (such as meta-information hyperlinks) and/or embedded instructions (such as JavaScript scripts).

To facilitate searching of resources 105, environment 100 can include a search system 112 that identifies the resources 105 by crawling and indexing the resources 105 provided by the content publishers on the Web sites 104. Data about the resources 105 can be indexed based on the resource 105 to which the data corresponds. The indexed and, optionally, cached copies of the resources 105 can be stored in an indexed cache 114.

An example user device 106a is an electronic device that is under control of a user and that is capable of requesting and receiving resources over the network 102. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 106a typically stores one or more user applications, such as a Web browser, to facilitate the sending and receiving of data over the network 102. A user device 106a that is mobile (or simply, “mobile device”), such as a smartphone or a table computer, can include an application (“app”) 107 that allows the user to conduct a network (e.g., Web) search. User devices 106 can also be equipped with software to communicate with a GPS system, thereby enabling the GPS system to locate the mobile device.

User device 106a can request resources 105 from a Web site 104a. In turn, data representing the resource 105 can be provided to the user device 106a for presentation by the user device 106a. User devices 106 can also submit search queries 116 to the search system 112 over the network 102. A request for a resource 105 or a search query 116 sent from a user device 106 can include an identifier, such as a cookie, identifying the user of the user device.

In response to a search query 116, the search system 112 can access the indexed cache 114 to identify resources 105 that are relevant to the search query 116. The search system 112 identifies the resources 105 in the form of search results 118 and returns the search results 118 to a user device 106 in search results pages. A search result 118 can include data generated by the search system 112 that identifies a resource 105 that is responsive to a particular search query 116, and includes a link to the resource 105. An example search result 118 can include a Web page title, a snippet of text or a portion of an image obtained from the Web page, and the URL (Unified Resource Location) of the Web page.

Content management system 110 can be used for selecting and providing content in response to requests for content. Content management system 110 also can, with appropriate user permission, update database 124 based on activity of a user. The user may enable and/or disable the storing of such information. In this regard, with appropriate user permission, the database 124 can store a profile for the user which includes, for example, information about past user activities, such as visits to a place or event, past requests for resources 105, past search queries 116, other requests for content, Web sites visited, or interactions with content. User interests may also be stored in the profile and, in some examples, may be determined from the information about past user activities. In some implementations, the information in database 124 can be derived, for example, from one or more of a query log, an advertisement log, or requests for content. The database 124 can include, for each entry, a cookie identifying the user, a timestamp, an IP (Internet Protocol) address associated with a requesting user device 106, a type of usage, and details associated with the usage.

Content management system 110 may include a keyword matching engine 140 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 110 may include a geographic (or “geo-”) matching engine 141 to compare geographic information (e.g., numerical values for place names) obtained from words in input queries to geographic information associated with content. Content management system 110 may also include other engines (not shown) for matching input demographics to desired demographics of an ad campaign, for identifying Web pages or other distribution mechanisms based on content, and so forth.

When a resource 105 or search results 118 are requested by a user device 106, content management system 110 can receive a request for content to be provided with the resource 105 or search results 118. The request for content can include characteristics of one or more slots that are defined for the requested resource 105 or search results page. For example, the data representing the resource 105 can include data specifying a portion of the resource 105 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 110. For example, a reference (e.g., URL) to the resource for which the slot is defined, a size of the slot, and/or media types that are available for presentation in the slot can be provided to the content management system 110. Similarly, keywords associated with a requested resource or a search query 116 for which search results are requested can also be provided to the content management system 110 to facilitate identification of content that is relevant to the resource or search query 116.

Based at least in part on data generated from and/or included in the request, content management system 110 can select content that is eligible to be provided in response to the request (“eligible content items”). Content management system 110 can select the eligible content items that are to be provided for presentation in slots of a resource 105 or search results page 118 based, at least in part, on results of an auction, such as a second price auction. For example, for eligible content items, content management system 110 can receive bids from content providers (e.g., advertisers 108) and allocate the content to slots, based at least in part on the received bids (e.g., based on the highest bidders at the conclusion of the auction). The bids are amounts that the content providers are willing to pay for presentation (or selection) of their content with a resource 105 or search results page 118. For example, a bid can specify an amount that a content provider is willing to pay for each 1000 impressions (i.e., presentations) of the content item, referred to as a CPM bid. Alternatively, the bid can specify an amount that the content provider is willing to pay for a selection (i.e., a click-through) of the content item or a conversion following selection of the content item. This is referred to as cost-per-click (CPC). The selected content item can be determined based on the bids alone, or based on the bids of each bidder being multiplied by one or more factors, such as quality scores derived from content performance, landing page scores, and/or other factors.

In some implementations, TV (Television) broadcasters 134 produce and present television content on TV user devices 136, where the television content can be organized into one or more channels. The TV broadcasters 134 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 110 may include a pack engine 142. Pack engine 142 may implement all or part of the example processes described herein for providing tiered packs of inventory for distribution at a content auction.

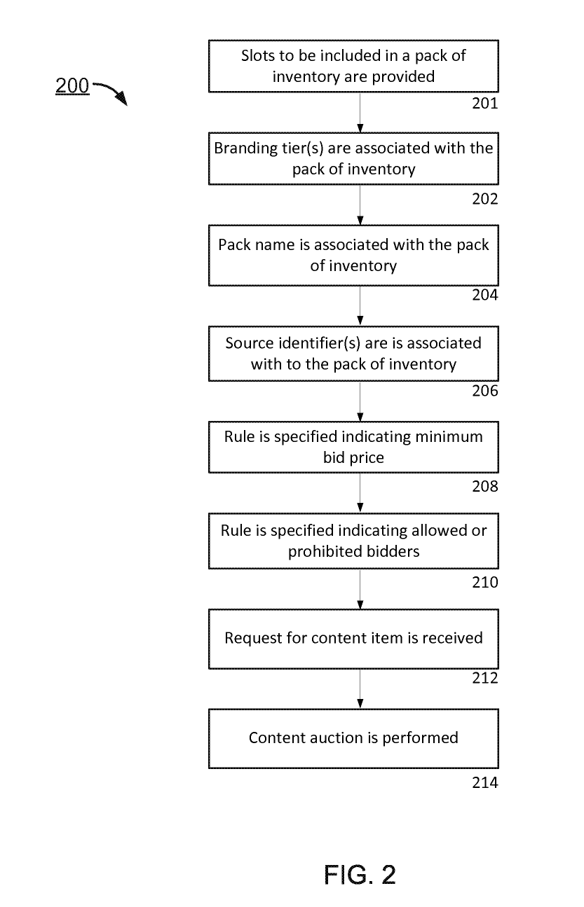

Referring to FIG. 2, in a process 200 to provide one or more packs of inventory, content item slots (also referred to as slots) to be included in a pack of inventory are provided (201). For example, the slots may be provided by one or more publishers. In an example, a single publisher can provide a pack of inventory including slots from one or more pages in a single domain. In an example, a group of publishers belonging to a consortium can provide a pack of inventory including slots from pages in multiple domains. For instance, a group of news reporting publishers may belong to a consortium called “News-Group” and may provide a pack of inventory including slots from one or more pages associated with one or more of the publishers in the consortium. In an example, an owner or operator of the content management system 110 can assemble a pack of inventory from one or more publishers. Inventory from a particular publisher can be included in the assembled pack of inventory with permission from the publisher.

One or more of multiple branding tiers is associated with the pack of inventory (202), e.g., by the one or more publishers providing the pack of inventory. For instance, three branding tiers can be available, and the publisher can designate the pack as an anonymous pack, a semi-transparent pack, or a branded pack. The amount of information about the pack that is exposed to bidders is controlled by the branding tier of the pack. In some examples, the publisher can provide the same inventory in multiple packs, with a different branding level assigned to each pack. That is, the same inventory can be presented with varying amounts of information.

A pack name is associated with the pack of inventory (204). For instance, the pack name can be specified by the one or more publishers. In some examples, the pack name can describe the topic of the pages on which the slots in the pack appear (e.g., “Shopping” or “Politics”). In some examples, the pack name can describe a technical feature of the slots that may be of interest to a content provider (e.g., “above the fold”). In some examples, the pack name can be a generic placeholder (e.g., “all inventory”). Because the pack name is specified by the publisher in this example, the publisher has control over what information is exposed about the pack. In some examples, when the same inventory is presented as multiple packs with different branding levels, the publisher can specify the same pack name for each branding level. In some examples, the publisher can specify a different pack name for each branding level.

One or more source identifiers are associated with the pack of inventory (206). For instance, the source identifiers can be specified by the one or more publishers. Each source identifier may also be associated with a branding tier associated with the pack of inventory. For example, if the pack of inventory is an anonymous pack, an anonymous identifier is automatically associated with the pack as its source identifier. The anonymous identifier provides no information about the publisher of the pack or the domain(s) or URLs of the slots included in the pack. Thus, inventory from different domains can be indistinguishably combined into an anonymous pack, with no information about the number or identity of the domains exposed to bidders. In general, any anonymous identifier can be assigned, provided the anonymous identifier does not overlap with another anonymous identifier assigned to another pack. For instance, a length of the anonymous identifiers may be specified (e.g., 10 digits) such that a sufficient number of anonymous identifiers are available. In some cases, anonymous identifiers can be assigned per domain or per publisher but without exposing the identity of the domain or the publisher. In these cases, bidders can recognize inventory that is sourced from a common domain or a common publisher even though the identity of that domain or publisher is not revealed.

If the pack of inventory is a semi-transparent pack, the source identifier associated with the pack may be specified by the publisher. The source identifier can reveal as much information about the source of the inventory as desired by the publisher. For instance, the source identifier can be a pseudonym or descriptive phrase for the publisher. The source identifier can be a name of a consortium to which the publisher(s) belongs, e.g., if the publisher wants to keep the individual brands of the inventory private and expose only high-level information about the consortium. The source identifier can identify a domain (e.g., newstoday.com) without identifying the specific URLs of the pages on which the inventory appears, e.g., if the publisher wants to cause bidders to bid on slots from a general domain rather than slots with specific URLs.

If the pack of inventory is a branded pack, the source identifier associated with the pack may identify the publisher. In addition, the designation of a pack of inventory as a branded pack causes detailed information about the inventory, specified by the publisher, to be exposed to bidders. For instance, information such as the exact identity of the publisher, the domain and specific URLs of the pages on which the inventory appears, or other information can be exposed to bidders. In some implementations, this detailed information can be provided to bidders along with the source identifier and the pack name.

In some examples, the source identifier can be audited, edited, or both, to conform the source identifier to content and/or format requirements. These requirements can be imposed by format requirements for existing content auction systems, such as format requirements imposed on inventory channels. For instance, in order for downstream content auction processing of a pack of inventory to recognize the branding tier of the pack, a prefix can be prepended onto each source identifier. For instance, the prefixes “pack-brand-,” “pack-semi-,” and “pack-anon-” can be prepended onto source identifiers for branded packs, semi-transparent packs, and anonymous packs, respectively.

Other requirements for the source identifier can include length requirements (e.g., a source identifier can be no less than 250 bytes and no more than 64 bytes) and character requirements (e.g., a source identifier can contain only alphanumeric characters or certain special characters). Requirements can also include content requirements, such as that a source identifier cannot be a name that is offensive, a name that represents the publisher as another entity, or a name that is copyrighted or trademarked by an entity other than the publisher of the pack with that source identifier.

A rule can be specified, e.g., by the publisher, indicating a minimum bid price for the pack of inventory (208), such as a minimum CPM or a minimum CPC. The minimum bid price can be specified per branding tier. For instance, when the same inventory is presented as multiple packs with different branding tiers, the publisher can specify a different minimum bid price for each branding tier. That is, publishers can control how much information is exposed to bidders and can charge a premium for access to more detailed information. In some examples, the publisher can specify a minimum bid price on a per-bidder basis such that each bidder may be subject to a different minimum bid price for the same pack of inventory at the same branding tier.

A rule can be specified, e.g., by the publisher, identifying bidders that are allowed to bid on the pack of inventory, prohibited from bidding on the pack of inventory, or both (210). For instance, when the same inventory is presented as multiple packs with different branding tiers, the publisher can identify different bidders that are allowed to bid on packs from each branding tier. In some examples, a publisher can allow a particular bidder to bid on either a branded pack or an anonymous pack of the same inventory while prohibiting the bidder from bidding on the semi-transparent pack of that inventory. For instance, a publisher can enable a private content exchange to be established in which only certain bidders are allowed access to certain high-quality, branded inventory.

A request for a content item associated with the inventory of content item slots is received (212). In response to the request, a content auction is performed (214), e.g., through a content exchange. Information about the pack of inventory associated with the requested content item can be provided based on the branding tier of the pack of inventory. For instance, the source identifier and pack name for each pack of inventory can beprovided. The particular source identifier that is provided is dependent on the branding tier of the pack of inventory. Other information about each pack of inventory can also be provided, depending on the branding tier of the pack of inventory.

A pack of inventory can be bid on by a bidder as an inventory channel by its associated source_identifier::pack_name tuple, referred to as its auction name. The pack name may be specified by the publisher. The amount of information exposed through the source identifier is determined based on the publisher's selection of the branding tier for the pack and the publisher's specification of the source identifier itself. Thus, the publisher has control over the amount of information that is presented in the auction name of a pack of inventory.

A publisher can link a pack of inventory to one or more established inventory segments, such as inventory segments established based on URL, size, domain, geo, or other features. In some examples, a publisher can define a list of packs (e.g., by the associated source_identifier::pack_name tuples) to be associated with a particular inventory segment. A particular pack can be associated with more than one inventory segment. In some examples, any pack that satisfies the criteria of an inventory segment is automatically associated with that segment. In some examples, packs can provided to a content auction independently of any inventory segment.

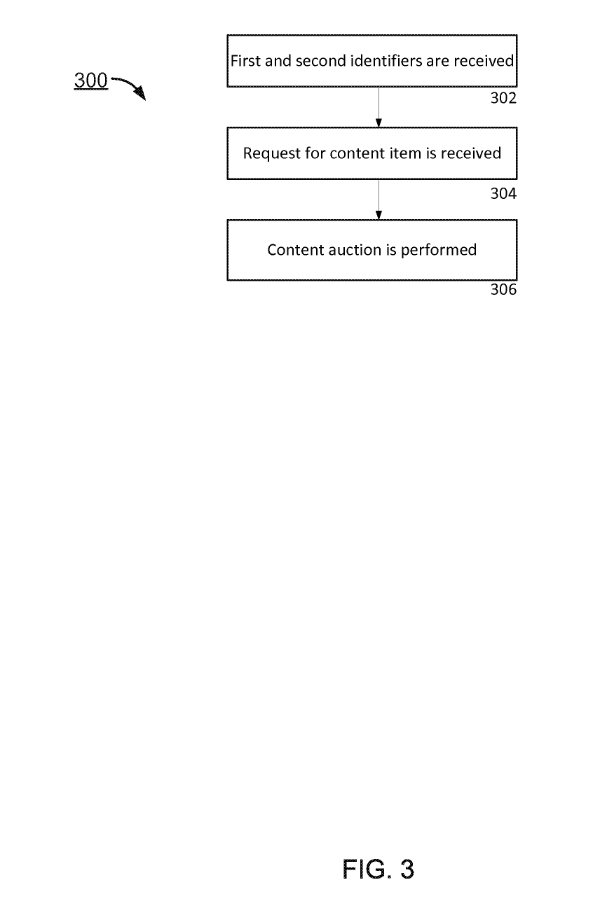

Referring to FIG. 3, in a process 300 to provide a particular pack of inventory, a first identifier and a second identifier are received from one or more publishers (302). The publishers have associated inventory of one or more content item slots associated with resources of the publishers. The first identifier, which can be specified by the publishers, is associated with the one or more publishers and is associated with a branding tier. The pack name, which can be specified by the publishers, is associated with the inventory of content item slots.

A request for a content item associated with the inventory of content item slots and associated with a particular resource of the publishers is received (304). In response to the request, a content auction is performed (306). The information provided in the content auction is based at least in part on the branding tier and includes the first identifier and the second identifier but not the particular resource.

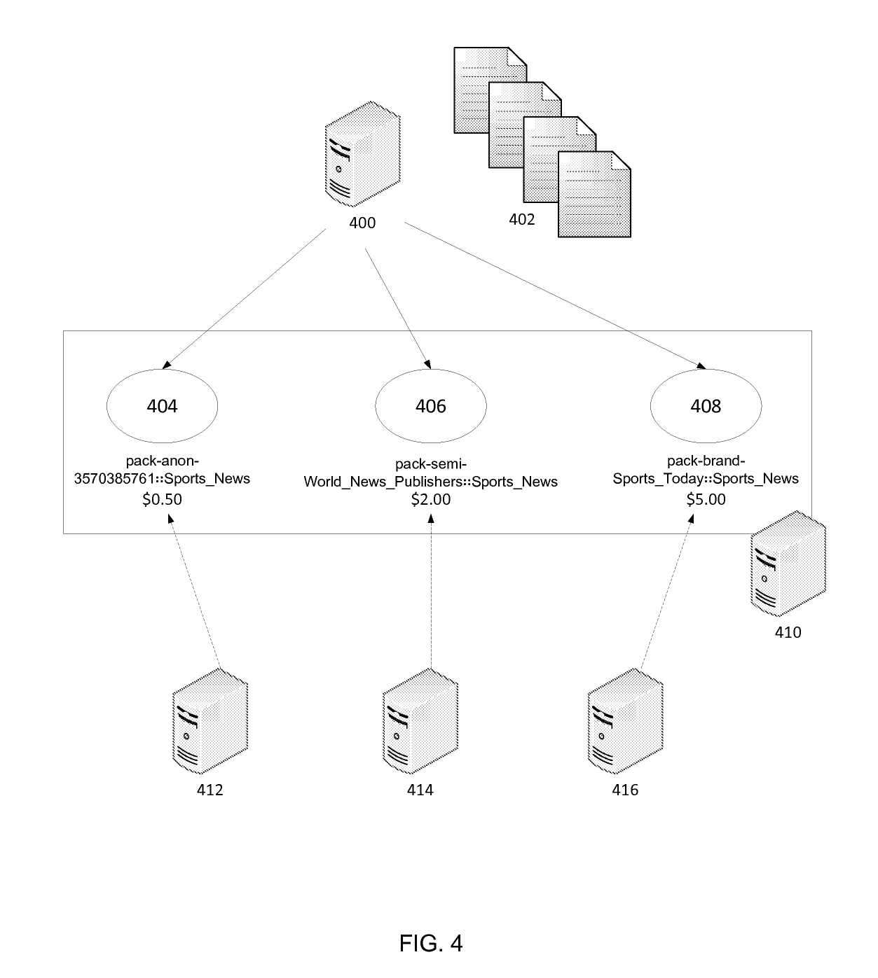

Referring to FIG. 4, in a specific example, a publisher called “Sports Today” belongs to a consortium of publishers called “World News Publishers.” The publisher 400 provides inventory 402 that includes slots on multiple sports news pages. The publisher specifies three packs of inventory that each include the same inventory 402: an anonymous pack 404, a semi-transparent pack 406, and a branded pack 408. The pack name for each pack is specified by the publisher to be “Sports_News.”

The source identifier for the anonymous pack 404 is randomly assigned and the auction name of the anonymous pack 404 becomes “pack-anon-3570385761::Sports_News.” In a content auction operated by a content exchange 410, a bidder 412 that may bid on the anonymous pack 404 thus is only given information about the general topic of the inventory in the anonymous pack. The publisher 400 can establish a minimum bid price for any bidder 412 bidding on the anonymous pack 404, such as $0.50 CPM. The publisher 400 can also identify specific bidders 412 that are allowed to bid on the anonymous pack 404, prohibited from bidding on the anonymous pack 404, or both.

The source identifier for the semi-transparent pack 406 is specified by the publisher 400. In this example, the publisher specifies the name of the consortium as the source identifier and the auction name of the semi-transparent pack 406 becomes “pack-semi-World_News_Publishers::Sports_News.” In a content auction, a bidder 414 that may bid on the semi-transparent pack 406 thus is given information about the general topic of the inventory in the semi-transparent pack and the general source of the inventory, but cannot identify the specific publisher, domain, or URL of the inventory. The publisher 400 can establish a minimum bid price for any bidder 414 bidding on the semi-transparent pack 406, such as $2.00 CPM. The publisher 400 can also identify specific bidders 414 that are allowed to bid on the semi-transparent pack 406, prohibited from bidding on the semi-transparent pack 406, or both.

The source identifier for the branded pack 408 is specified by the publisher to be the name of the publisher. The auction name of the branded pack 408 becomes “pack-brand-Sports_Today::Sports_News.” In a content auction, a bidder 416 that may bid on the branded pack 408 thus is given information about the general topic of the inventory in the branded pack and the specific identity of the publisher of the branded pack. In addition, the prefix “pack-brand” signals the content auction to expose further information, such as the domain and specific URLs associated with the inventory. The publisher 400 can establish a minimum bid price for any bidder 414 bidding on the branded pack 408, such as $5.00 CPM. The publisher 400 can also identify specific bidders 416 that are allowed to bid on the branded pack 408, prohibited from bidding on the branded pack 408, or both.

In some examples, a publisher can define a default pack for each branding level. The default pack can contain all the inventory provided by the publisher. The default pack can act as a fail-safe case to ensure that the publisher's inventory is available in at least one pack for each branding level. For instance, if a publisher defines an entirely new set of inventory but fails to create a pack specifically for that inventory, the default pack will automatically include that newly defined inventory.

In some examples, the pricing infrastructure of an existing content exchange supports a two-tiered pricing model in which inventory is provided at either a branded price or an anonymous price. In these examples, when packs of inventory are made available through such two-tiered content exchanges, the three-tiered distribution of information about the packs of inventory can be mapped to the two-tiered pricing of the content exchange. For instance, anonymous packs can be mapped to the anonymous pricing tier of the content exchange. Both semi-transparent packs and branded packs can be mapped to the branded pricing tier of the content exchange.

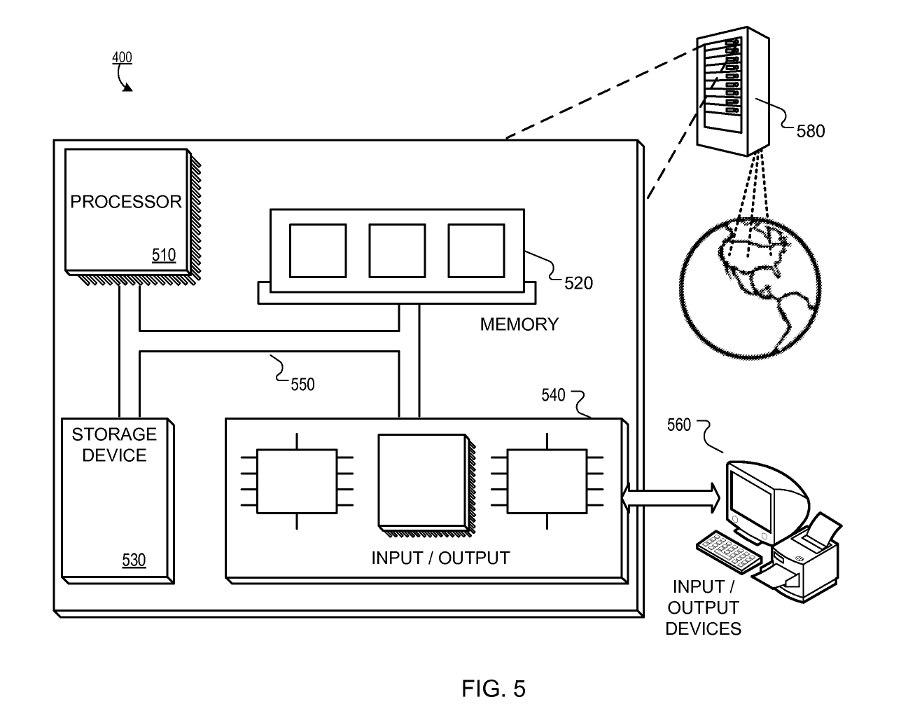

FIG. 5 is block diagram of an example computer system 500 that may be used in performing the processes described herein, including process 200 and its various modifications. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 560.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 500 is depicted as a rack in a server 580 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads, may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

1. A method performed by one or more processing devices, comprising:
receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier;
receiving a request for a content item associated with the inventory of content item slots; and
in response to the request, performing a content auction, including providing the first identifier, the second identifier, or both, based on the branding tier.

2. The method of claim 1, wherein the first identifier comprises one or more of an identifier of the one or more publishers, an identifier descriptive of the one or more publishers, an identifier of a consortium to which the one or more publishers belong, and an identifier descriptive of a domain associated with the inventory.

3. The method of claim 1, wherein the second identifier comprises an identifier descriptive of a topic associated with the inventory of content item slots, an identifier descriptive of a technical feature associated with the inventory of content item slots, or both.

4. The method of claim 1, wherein performing the auction comprises providing a domain associated with the requested content item, a resource associated with the requested content item, or both, based on the branding tier.

5. The method of claim 1, wherein performing the auction comprises providing an anonymous identifier associated with the one or more publishers based on the branding tier.

6. The method of claim 1, comprising receiving, from the one or more publishers, a specification of the branding tier.

7. The method of claim 1, wherein the first identifier is associated with one or more of at least three branding tiers.

8. The method of claim 1, comprising receiving, from the one or more publishers, a rule associated with the inventory of content item slots.

9. The method of claim 8, wherein the rule is associated with the branding tier.

10. The method of claim 8, wherein the rule is indicative of one or more content providers that are allowed to bid on a content item slot associated with the inventory of content item slots, one or more content providers that are not allowed to bid on a content item slot associated with the inventory of content item slots, or both.

11. The method of claim 8, wherein the rule is indicative of a minimum price associated with the inventory of content item slots.

12. One or more machine-readable storage media storing instructions that are executable by one or more processing devices to perform operations comprising:
receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier;
receiving a request for a content item associated with the inventory of content item slots; and
in response to the request, performing a content auction, including providing the first identifier, the second identifier, or both, based on the branding tier.

13. A system comprising:
a content management system for performing operations comprising:
receiving, from one or more publishers having an associated inventory of one or more content item slots, (i) a first identifier specified by the one or more publishers and associated with the one or more publishers and (ii) a second identifier specified by the one or more publishers and associated with the inventory of content item slots, wherein the first identifier is associated with a branding tier;
receiving a request for a content item associated with the inventory of content item slots; and
in response to the request, performing a content auction, including providing the first identifier, the second identifier, or both, based on the branding tier.

14. A method performed by one or more processing devices, comprising:
receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier;
receiving a request for a content item associated with the inventory of content item slots and associated with a particular resource of the one or more publishers; and
in response to the request, performing a content auction in which the information provided in the content auction is based at least in part on the branding tier and includes the first identifier and the second identifier but not the particular resource.

15. The method of claim 14, wherein the first identifier comprises one or more of an identifier descriptive of the one or more publishers, an identifier of a consortium to which the one or more publishers belong, and an identifier descriptive of a domain associated with the inventory.

16. The method of claim 14, wherein the first identifier, the second identifier, or both, are specified by the one or more publishers.

17. The method of claim 14, wherein the second identifier comprises an identifier descriptive of a topic associated with the inventory of content item slots, an identifier descriptive of a technical feature associated with the inventory of content item slots, or both.

18. The method of claim 14, comprising receiving, from the one or more publishers, a rule associated with the inventory of content item slots.

19. The method of claim 18, wherein the rule is indicative of one or more content providers that are allowed to bid on a content item slot associated with the inventory of content item slots, one or more content providers that are not allowed to bid on a content item slot associated with the inventory of content item slots, or both.

20. The method of claim 18, wherein the rule is indicative of a minimum price associated with the inventory of content item slots.

21. One or more machine-readable storage media storing instructions that are executable by one or more processing devices to perform operations comprising:
receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier;
receiving a request for a content item associated with the inventory of content item slots and associated with a particular resource of the one or more publishers; and
in response to the request, performing a content auction in which the information provided in the content auction is based at least in part on the branding tier and includes the first identifier and the second identifier but not the particular resource.

22. A system comprising:
a content management system for performing operations comprising:
receiving, from one or more publishers having an associated inventory of one or more content item slots associated with resources of the one or more publishers, (i) a first identifier associated with the one or more publishers and (ii) a second identifier associated with the inventory of content item slots, wherein the first identifier is associated with a branding tier;
receiving a request for a content item associated with the inventory of content item slots and associated with a particular resource of the one or more publishers; and
in response to the request, performing a content auction in which the information provided in the content auction is based at least in part on the branding tier and includes the first identifier and the second identifier but not the particular resource.
